(19) United States
(12) Patent Application Publication
(10) Pub. No.: US 2016/0052640 A1
(43) Pub. Date: Feb. 25, 2016

(54) HEALTH MANAGEMENT UNIT AND METHOD FOR MONITORING HEALTH INFORMATION AND METHOD OF REPORTING CRITICAL FAILURE INFORMATION

(71) Applicant: GE Aviation Systems LLC, Grand Rapids, MI (US)

(72) Inventors: Eric Daniel Buehler, Grand Rapids, MI (US); Dawn Marie Stanek, Ada, MI (US)

(21) Appl. No.: 14/464,262

(22) Filed: Aug. 20, 2014

(51) Int. Cl. B64D 45/00

(52) U.S. Cl. CPC B64D 45/00

(57) ABSTRACT

A health management unit for an aircraft and method of reporting critical failure information, in an aircraft having a health management unit that includes determining by the health management unit a potential catastrophic event during the flight of the aircraft based on data received by the health management unit and assembling by the health management unit data indicative of a report of the aircraft state of operation upon the determining of a potential catastrophic event.

### BACKGROUND OF THE INVENTION

Contemporary aircraft may include a variety of avionics systems to assist in flying the aircraft. Such systems may collect various aircraft data for any irregularities or other signs of a fault or problem with the aircraft. A flight recorder may record information regarding such irregularities and if the flight recorder is found such information may be analyzed to determine what occurred on the aircraft.

### BRIEF DESCRIPTION OF THE INVENTION

In one aspect, an embodiment of the invention relates to a method of reporting critical failure information, in an aircraft having a health management unit, the method includes determining by the health management unit a potential catastrophic event during the flight of the aircraft based on data received by the health management unit, assembling by the health management unit data indicative of a report of the aircraft state of operation upon the determining of a potential catastrophic event, and transmitting the assembled data from the aircraft during the flight of the aircraft.

In another aspect, an embodiment of the invention relates to a health management unit for an aircraft having multiple systems for operating the aircraft and at least one off-board transmission interface for transmitting a message off the aircraft, the health management unit having a computer configured to determine a potential catastrophic event during the flight of the aircraft, assemble data indicative of a report of the aircraft state of operation upon the determining of a potential catastrophic event and controls transmission of the assembled data from the aircraft during the flight of the aircraft.

### BRIEF DESCRIPTION OF THE DRAWINGS

In the drawings:

FIG. 1 is a perspective view of an aircraft in which embodiments of the invention may be implemented.

FIG. 2 is a flowchart showing a method of reporting critical failures according to an embodiment of the invention.

FIG. 3 is a diagram showing an exemplary method of reporting critical failures according to an embodiment of the invention.

### DESCRIPTION OF EMBODIMENTS OF THE INVENTION

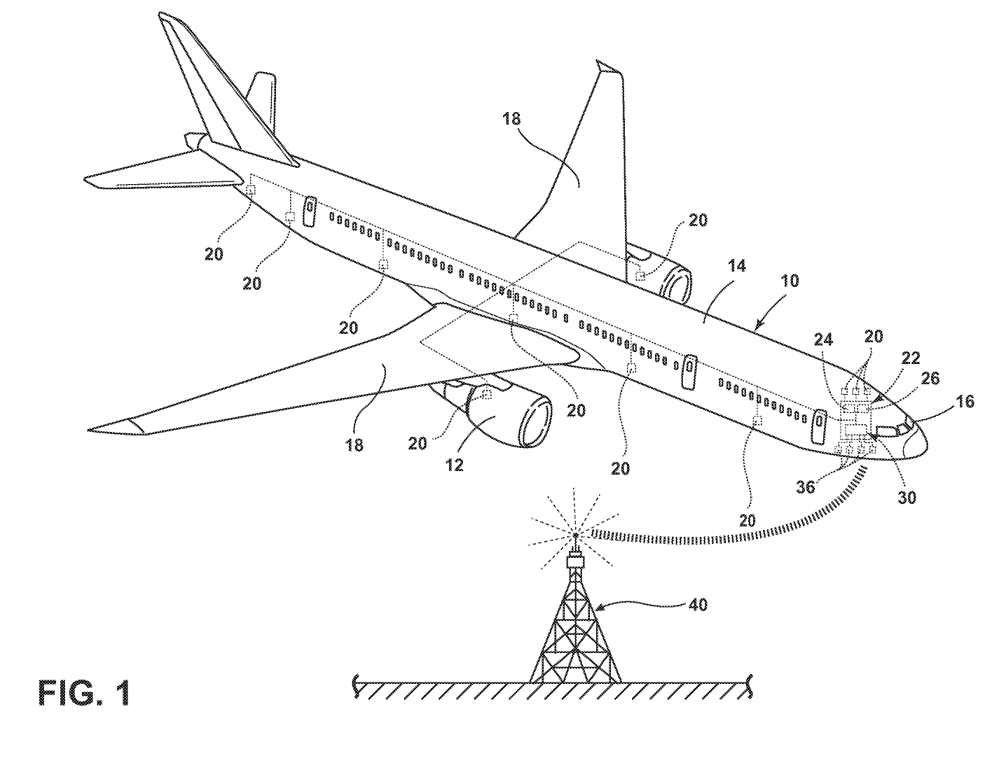

FIG. 1 schematically depicts an aircraft 10 that may execute embodiments of the invention and may include one or more propulsion engines 12 coupled to a fuselage 14, a cockpit 16 positioned in the fuselage 14, and wing assemblies 18 extending outward from the fuselage 14. While a commercial aircraft has been illustrated, it is contemplated that embodiments of the invention may be used in any type of aircraft, for example, without limitation, fixed-wing, rotating-wing, rocket, personal aircraft, and military aircraft.

A plurality of aircraft systems 20 that enable proper operation of the aircraft 10 may also be included in the aircraft 10 as well as one or more computers or controllers 22, which may be operably coupled to the plurality of aircraft systems 20 to control their operation. While only a single controller 22 has been illustrated, it is contemplated that any number of controllers 22 may be included in the aircraft 10. In such an instance, the controller 22 may also be connected with other controllers of the aircraft 10. The controller 22 may include or be associated with any suitable number of individual microprocessors, power supplies, storage devices, interface cards, auto flight systems, flight management computers, and other standard components. For example, the controller 22 may include memory 24, the memory 24 may include random access memory (RAM), read-only memory (ROM), flash memory, or one or more different types of portable electronic memory, such as discs, DVDs, CD-ROMs, etc., or any suitable combination of these types of memory. The controller 22 may also include one or more processors 26, which may be running any suitable programs. The controller 22 may include or cooperate with any number of software programs or instructions designed to carry out the various methods, process tasks, calculations, and control/display functions necessary for operation of the aircraft 10. The computer 22 is illustrated as being in communication with the plurality of aircraft systems 20 and it is contemplated that the computer 22 may aid in operating the aircraft systems 20 and may receive information from the aircraft systems 20. The controller 22 may be a portion of an FMS, HMS, etc.

Further, a health management unit 30 has been illustrated as being included within the aircraft 10. The health management unit 30 may also be operably coupled to any number of the plurality of aircraft systems and/or controllers to receive information therefrom. While illustrated as being included in the controller 22, the health management unit 30 may also be separate from the controller 22 or may be a part of any of the avionics systems that have access to off-board interfaces like an integrated modular avionics, onboard maintenance system, flight data recorder, etc. The health management unit 30 may collect or receive information, determine a critical failure or potential catastrophic event, assemble data that may not normally be collected, and transmit such data.

The health management unit 30 may be implemented in any suitable software or hardware. For example, the health management unit 30 might include a general-purpose computing device in the form of a computer, including a processing unit, a system memory, and a system bus, that couples various system components including the system memory to the processing unit. The computer may be configured to determine a potential catastrophic event during the flight of the aircraft, assemble data indicative of a report of the aircraft state of operation upon the determining of a potential catastrophic event and controls transmission of the assembled data from the aircraft during the flight of the aircraft. The computer may also prepare a predefined report from the assembled data and transmit it. The computer may retrieve data from the aircraft and off-board data interfaces for the predefined report indicating the aircraft state of operation.

The health management unit 30 may include all or a portion of one or more computer programs having executable instruction sets for reporting critical failure information of the aircraft 10 and transmitting information from the aircraft 10. The program may include a computer program product that may include machine-readable media for carrying or having machine-executable instructions or data structures stored thereon. Such machine-readable media may be any available media, which can be accessed by a general purpose or special purpose computer or other machine with a processor. Generally, such a computer program may include routines, programs, objects, components, data structures, algorithms, etc. that have the technical effect of performing particular tasks or implementing particular abstract data types. Machine-executable instructions, associated data structures, and programs represent examples of program code for executing the exchange of information as disclosed herein. Machine-executable instructions may include, for example, instructions and data, which cause a general-purpose computer, special purpose computer, or special-purpose processing machine to perform a certain function or group of functions.

The controller 22 and/or the health management unit 30 may be communicably coupled to any number of communication links 36 to transfer data to and from the aircraft 10. Alternatively, the computer of the health management unit 30 may include a communication management module configured to determine what one of the multiple radios to use in transferring the data based on bandwidth, availability, or current utilization. It is contemplated that the communication links 36 may be wireless communication links and may be any variety of communication mechanism capable of wirelessly linking with other systems and devices and may include, but is not limited to, packet radio, satellite uplink, Wireless Fidelity (WiFi), WiMax, Bluetooth, ZigBee, 3G wireless signal, code division multiple access (CDMA) wireless signal, global system for mobile communication (GSM), 4G wireless signal, long term evolution (LTE) signal, Ethernet, or any combinations thereof. It will also be understood that the particular type or mode of wireless communication is not critical to embodiments of the invention, and later-developed wireless networks are certainly contemplated as within the scope of embodiments of the invention. Further, the communication links 36 may include one or more radios including voice, ACARS-analog, ACARS-digital, SATCOM, Cellular, etc. The communication links 36 may allow for communication with ground controllers or airlines operations center at a ground-based station 40 or with non-ground stations such as satellite (not shown). Further, while only one ground-based station 40 has been illustrated, it will be understood that the aircraft may communicate with multiple ground-based stations 40 utilizing the communication links 36.

During operation, the health management unit 30 may utilize inputs from the plurality of aircraft systems 20 to determine a potential catastrophic event. By way of non-limiting example, the health management unit 30 may be preconfigured to recognize key events that are considered potentially catastrophic. As the health management unit 30 monitors the aircraft 10 and its systems 20, upon detection of a catastrophic event, the health management unit 30 may begin to establish connections to any number of on-board systems 20 including by way of non-limiting examples a health management system and a navigation system and off-board data through communication links 36 and assemble data related to operational data, location data, and critical data related to the aircraft 10.

For example, the health management unit 30 may assemble a preconfigured summary report of the aircraft state, position, and nature of the failure. The health management unit 30 may then transmit the assembled data or may control the transmission of the data over the communication links 36 for receipt by ground-based stations 40. The health management unit 30 may continue to broadcast the report or updated versions of the report for the duration of flight and/or until communication is no longer available. The health management unit 30 may be configured to recognize a potential catastrophic event as a single piece of information from a system 20 in the aircraft 10 or as a combination of events that need to be aggregated by the health management unit 30 to recognize that the aircraft 10 is in a potential catastrophic state.

It will be understood that details of environments that may implement embodiments of the invention are set forth in order to provide a thorough understanding of the technology described herein. It will be evident to one skilled in the art, however, that the exemplary embodiments may be practiced without these specific details. The exemplary embodiments are described with reference to the drawings. These drawings illustrate certain details of specific embodiments that implement a module or method, or computer program product described herein. However, the drawings should not be construed as imposing any limitations that may be present in the drawings. The method and computer program product may be provided on any machine-readable media for accomplishing their operations. The embodiments may be implemented using an existing computer processor, or by a special purpose computer processor incorporated for this or another purpose, or by a hardwired system.

As noted above, embodiments described herein may include a computer program product comprising machine-readable media for carrying or having machine-executable instructions or data structures stored thereon. Such machine-readable media may be any available media, which may be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium that can be used to carry or store desired program code in the form of machine-executable instructions or data structures and that can be accessed by a general purpose or special purpose computer or other machine with a processor. When information is transferred or provided over a network or another communication connection (either hardwired, wireless, or a combination of hardwired or wireless) to a machine, the machine properly views the connection as a machine-readable medium. Thus, any such a connection is properly termed a machine-readable medium. Combinations of the above are also included within the scope of machine-readable media. Machine-executable instructions comprise, for example, instructions and data, which cause a general-purpose computer, special purpose computer, or special purpose processing machines to perform a certain function or group of functions.

Embodiments will be described in the general context of method steps that may be implemented in one embodiment by a program product including machine-executable instructions, such as program codes, for example, in the form of program modules executed by machines in networked environments. Generally, program modules include routines, programs, objects, components, data structures, etc. that have the technical effect of performing particular tasks or implement particular abstract data types. Machine-executable instructions, associated data structures, and program modules represent examples of program codes for executing steps of the method disclosed herein. The particular sequence of such executable instructions or associated data structures represent examples of corresponding acts for implementing the functions described in such steps.

Embodiments may be practiced in a networked environment using logical connections to one or more remote computers having processors. Logical connections may include a local area network (LAN) and a wide area network (WAN) that are presented here by way of example and not limitation. Such networking environments are commonplace in office-wide or enterprise-wide computer networks, intranets and the internet and may use a wide variety of different communication protocols. Those skilled in the art will appreciate that such network computing environments will typically encompass many types of computer system configurations, including personal computers, hand-held devices, multiprocessor systems, microprocessor-based or programmable consumer electronics, network PCs, minicomputers, mainframe computers, and the like.

Embodiments may also be practiced in distributed computing environments where tasks are performed by local and remote processing devices that are linked (either by hardwired links, wireless links, or by a combination of hardwired or wireless links) through a communication network. In a distributed computing environment, program modules may be located in both local and remote memory storage devices.

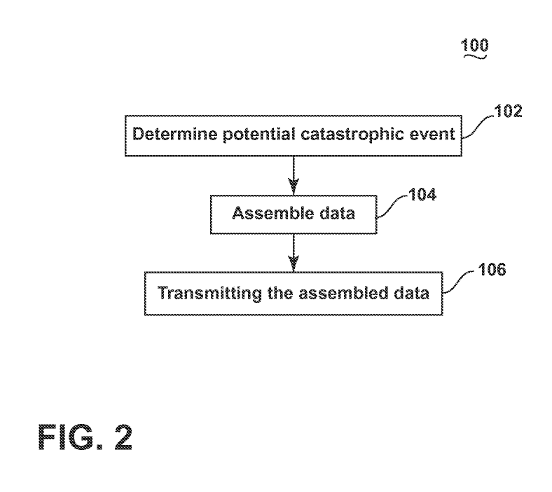

In accordance with an embodiment of the invention, FIG. 2 illustrates a method 100, which may be used for reporting critical failure information. The method 100 begins at 102 by determining a potential catastrophic event during the flight of the aircraft 10 based on data received by the health management unit 30. Determining the potential catastrophic event may include receiving data from at least one system 20 in the aircraft 10. It is also contemplated that the determining the potential catastrophic event may include aggregating data from multiple systems 20 of the aircraft 10. More specifically, the following are a few non-limiting examples of cases where a potential catastrophic event may be detected, which may result in the assembling of the fault report and its transmission. An aircraft stall may be a potential catastrophic event, which may be determined by detection of a stall, a determination of a decrease in airspeed at altitude, determination that engine pressure variation decreases to idle, a determination of an unacceptable descent rate of the aircraft, a determination that both engines flamed out, detection of airspeed below a predetermined indicated air speed, etc. An emergency landing may be a potential catastrophic event that could be determined based on descent rate of aircraft, altitude above ground level, proximity to planned approach location, etc. Further, a loss of control of the aircraft may be a potential catastrophic event that may be determined when the aircraft has inverted towards the ground. That the plane is running on emergency power may be a potential catastrophic event that may be determined when only the battery bus is available when the aircraft is still in flight. A loss of fuel, which may be a potential catastrophic event, may be determined by an engine status indication that the aircraft is running on fumes.

Upon the determining of a potential catastrophic event at 102, data indicative of a report of the aircraft state of operation may be assembled at 104. Data may be assembled by the health management unit 30 from systems of the aircraft 10 or connections to off-board interfaces may be established through the communication links 36. The assembled data may include data that aids in locating the aircraft or determining potential issues with the aircraft such as location, audio, airspeed, heading, descent speed, etc. For example, the health management unit 30 may collect data related to a critical state of the aircraft, operational data, or location data. It is contemplated that the data may be assembled in any suitable manner including that a preconfigured summary report may be prepared.

The assembled data may then be transmitted from the aircraft 10 during the flight of the aircraft 10 or until communication is unavailable via the communication link(s) 36. Any suitable communication link 36 may be utilized to transmit the assembled information. This may include that the assembled data may be repeatedly transmitted using the same or different communication links 36. It is also contemplated that the health management unit or a communications module or other processor may select which communication link(s) 36 is to transmit the assembled data. It is contemplated that the selection may be based on the most available and reliable radio.

It is contemplated that the various factors in determining if a potential catastrophic event has occurred or what data should be assembled may be factors in an algorithm or computer program comprising a set of executable instructions, which may be executed by the health management unit 30. In this manner, the health management unit 30 has visibility into the integrity of the aircraft systems and the ability to assemble data that may aid in locating the aircraft and determining potential problems that occurred. Once the communication link(s) 36 has been selected, the transmission may be transmitted.

It will be understood that the method 100 of reporting critical failure information is flexible and the method 100 illustrated is merely for illustrative purposes. For example, the sequence of steps depicted is for illustrative purposes only, and is not meant to limit the method 100 in any way, as it is understood that the steps may proceed in a different logical order or additional or intervening steps may be included without detracting from embodiments of the invention. By way of non-limiting example, the method 100 may also include assembling updated data and that such updated data may be transmitted and so on until transmission is no longer achievable. This may be particularly beneficial with respect to location and descent data of the aircraft.

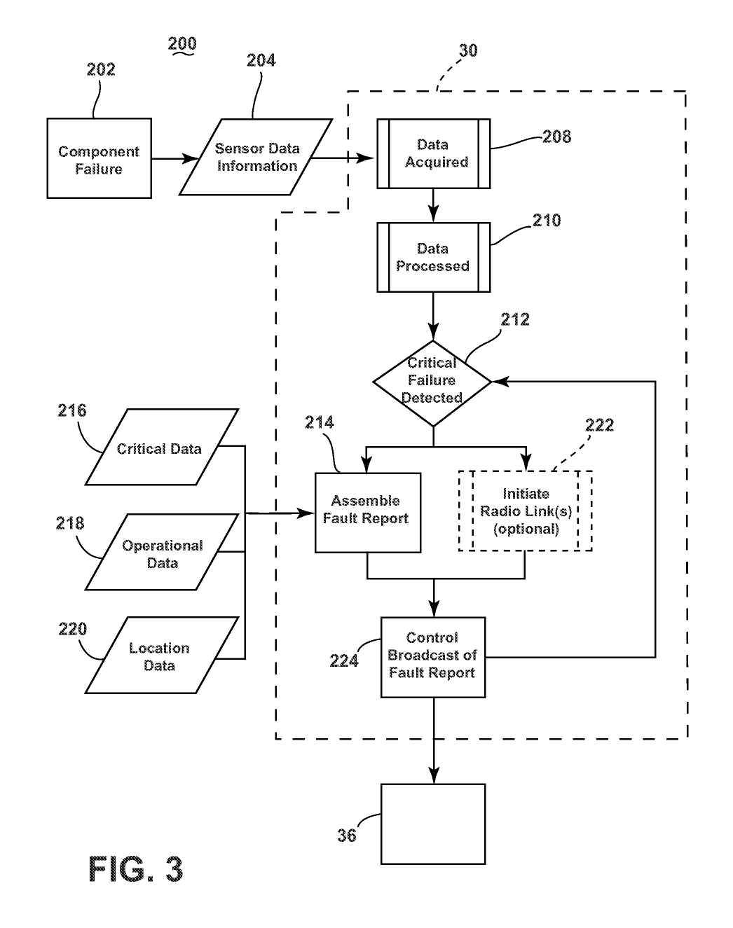

Further, FIG. 3 illustrates a diagram that may further aid in the understanding of embodiments of the invention. More specifically, it is illustrated in the diagram 200, that a component may fail at 202 and that the sensor data information 204 related to the failure may be provided. The data may be received by the health management unit 30 as shown at 208. The health management unit 30 may optionally process the received data at 210.

At 212, the health management unit 30 detects the critical failure or potential catastrophic event. While numerous steps are shown, it will be understood that the health management unit 30 may detect the critical failure in real time as the aircraft 10 is being flown. More specifically, the health management unit 30 may receive health-related information from one or more of the plurality of aircraft systems 20 and the data may then be processed to potentially catastrophic events. The health management unit 30 may process data relating to the aircraft, its flight performance, and selected signals related to health and usage and may compare such information to predetermined thresholds and determine a duration and/or extent by which any threshold is exceeded to determine a potential catastrophic event. For example, the health management unit 30 may have the ability to determine potential catastrophic events in the aircraft 10 through monitoring of conditions on the avionic buses.

Once this occurs, the health management unit 30 may assemble data including data not normally collected by the aircraft. This may be thought of as a mayday report or fault report as shown at 214. Such a report may include assembled critical data 216, which may be data for a failed component and any relevant controls, etc. Such assembled data may also include operational data 218 such as flight recorder data, cockpit status, etc. Such assembled data may also include location data 220 including for example GPS data regarding where the aircraft is heading including its speed and direction. In this manner, it will be understood that the assembled information may not be related to the failure or potentially catastrophic event but instead may be related to information that may help during search and rescue. For example, the report may include information that may act as a beacon that may be sent before the aircraft may no longer be used. The health management unit may then broadcast the report at 224 such as by sending the data through one or more of the communication links 36. It is also illustrated that the health management unit 30 may optionally initiate radio or communication links 36, such as at 222, although this need not be the case.

Traditionally flight data recorders are used to analyze what went wrong during a flight after a major incident. However, data within the recorders needs to be recovered from the aircraft before it can be analyzed. Additional provisions are put in the data recorder system to facilitate retrieval such as beacons but operators are at the mercy of the survivability of the recorder to help with the investigation of the crash. The above-described embodiments report information about the current state of the aircraft, to broadcast over available wireless links information about the aircraft state, position, and failure, so that the flight data recorder may be more easily found and so that information may be obtained from the aircraft in case of a catastrophic event. Further, the above-described embodiments when the data indicates a predetermined catastrophic event may send out the predetermined data for that event.

Technical effects of the above-described embodiments include the broadcasting of critical information about an aircraft, which may aid investigators in locating the aircraft and predetermining potential issues with the aircraft before recovery of equipment. This information may help the investigators determine aircraft model or fleet wide issues that may affect other aircraft that have not experienced the catastrophic event yet. The above embodiments may also provide additional benefits including a reduction in recovery costs and the ability for early detection of a systemic problem.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. (canceled)

2. The method of claim 16 wherein the determining the potential catastrophic event comprises receiving data from at least one system in the aircraft.

3. (canceled)

4. The method of claim 16 wherein the transmitting the predefined summary report comprises repeatedly transmitting the predefined summary report.

5. The method of claim 16 wherein the assembling of data further comprises aggregating, updated data and assembling the aggregated updated data.

6. The method of claim 5 wherein the transmitting the assembling of data further comprises transmitting the aggregated updated data.

7. The method of claim 16 wherein transmitting the predefined summary report off of the aircraft comprises selecting off-board interfaces to transmit the predefined summary report.

8. The method of claim 16 wherein the assembling of data comprises establishing connections to off-board interfaces.

9. (canceled)

10. The method of claim 16 wherein the assembling of data comprises collecting data related to a critical state of the aircraft, operational data, or location data.

11. The method of claim 16 wherein the assembling of data comprises collecting data that aids in locating the aircraft or determining potential issues with the aircraft.

12. (canceled)

13. (canceled)

14. (canceled)

15. (canceled)

16. A method of reporting critical failure information, in an aircraft having a health management unit, the method comprising:
aggregating data, by the health management unit, from multiple systems of the aircraft;
determining, by the health management unit, a potential catastrophic event during flight of the aircraft based on the aggregated data;
assembling, by the health management unit, at least a portion of the aggregated data indicative of a report of the aircraft state of operation upon the determining of a potential catastrophic event;
preparing a predefined summary report including the at least a portion of the aggregated data; and
transmitting the predefined summary report from the aircraft during the flight of the aircraft.

17. A method of reporting critical failure information, in an aircraft having a health management unit, the method comprising:
determining, by the health management unit, a potential catastrophic event during flight of the aircraft based on data received by the health management unit;
assembling, by the health management unit, data indicative of a report of the aircraft state of operation upon the determining of a potential catastrophic event;
preparing a predefined summary report including the assembled data;
determining, by the health management unit, at least one communication link for transmitting the predefined summary report based on at least one of availability or reliability of the communication link; and
transmitting the predefined summary report over the at least one communication link from the aircraft during the flight of the aircraft.
